(19) United States
(12) Patent Application Publication
(10) Pub. No.: US 2018/0358190 A1
(43) Pub. Date: Dec. 13, 2018

(54) EXTERNALLY-ASSEMBLED WATERPROOF SIDE KEY ASSEMBLY AND MOBILE TERMINAL INCLUDING SAME

(71) Applicant: BLUEBIRD INC., Seoul (KR)

(72) Inventors: Jang Won LEE, Seoul (KR); Se Jong PAIK, Seoul (KR); Sung Yeol KIM, Seoul (KR); Kyun Ha HAN, Incheon (KR)

(21) Appl. No.: 16/062,304

(22) PCT Filed: Dec. 14, 2016
(86) PCT No.: PCT/KR2016/014638

§ 371 Date: Jun. 14, 2018

(30) Foreign Application Priority Data
Dec. 14, 2015 (KR) 10-2015-0178316

(51) Int. Cl. H01H 13/06; H04B 1/3888; G06F 1/16

(52) U.S. Cl. CPC H01H 13/06; H01H 13/14; G06F 1/1656; H04B 1/3888

(57) ABSTRACT

Disclosed is an externally-assembled waterproof side key assembly and a mobile terminal including the same. The mobile terminal includes a terminal main body having a key assembly hole formed at at least a side thereof, and an externally-assembled waterproof side key assembly assembled from an outside of the terminal main body toward an area of the key assembly hole of the terminal main body. The externally-assembled waterproof side key assembly includes a side key having a protruding assembly terminal that is assembled by being inserted into the key assembly hole from the outside of the terminal main body, and a waterproof ring into which the protruding assembly terminal of the side key is inserted, the waterproof ring being disposed in the key assembly hole by being inserted into the key assembly hole from the outside of the terminal main body, and shielding a gap between the protruding assembly terminal and the key assembly hole for waterproof.

### TECHNICAL FIELD

The present inventive concept relates to an externally-assembled waterproof side key assembly and a mobile terminal including the same, and more particularly, to an externally-assembled waterproof side key assembly and a mobile terminal including the same, in which assembly may be possible with a minimum number of parts, thereby enabling miniaturization of a product, assemblability may be improved due to an external assembly method, thereby reducing generation of loss during manufacturing, and a waterproof function may be remarkably improved compared to the related art, thereby improving durability of a product.

### BACKGROUND ART

Mobile terminals are freely used while being carried regardless of places. Typical mobile terminals are mobile communication terminals such as mobile phones and personal digital assistants (PDAs) that are referred to as personal portable terminals.

Accordingly, the term “mobile terminal” used herein includes all of these terminals, but the PDA will be mainly discussed for convenience of explanation.

In a complex and diverse society, each individual needs to keep or maintain one's own information for each purpose. To meet the needs of each individual, various products have been released on the market and one of the products is the PDA.

The PDA, which is called a pocket computer, is a generic term for small handheld devices with computing, information storage, and searching capabilities for personal or business use, and is much used for maintaining schedule calendar and address book information.

In particular, currently, industrial PDAs are being much used mainly in the logistics industry, and the market is gradually expanding.

Industrial PDAs are PDAs equipped with a variety of office functions such as a barcode scanner and a credit card terminal that are not available in general PDAs. An industrial PDA is advantageous in that it can efficiently perform delivery, data management, and related tasks.

For example, in insurance companies, insurance planners can handle various insurance related tasks such as customer information management, customer search, schedule management, consultation journal management, anniversary search, and financial statement processing, directly on site using an industrial PDA. Next, in hospitals, patient's medical records and medical history, and prescriptions, as well as X-ray images and graphic data, can be input or retrieved by medical personnel using an industrial PDA regardless of time and places. Also, in the work of the police, the traffic and anticrime work of police officers on outside control duty can be carried out through the industrial PDA so that traffic violation fines that can be paid within 2-3 days after the enforcement is immediately paid to financial institutions Thus, it will be possible to dramatically shorten traffic and anticrime work hours of police officers on outside control duty.

As it can be seen from the fact that the industrial PDAs are used in the above-described various industrial fields, the industrial PDAs need to meet requirements of more than a certain level of enduring in an industrial environment, not a general environment, unlike general PDAs.

In other words, unlike the general PDAs, it may be natural to expect the industrial PDA to be used in a cold storage warehouse of below −10 degrees or outdoors for a long time, or to be carelessly used by a user such as a carrier for business purpose. Accordingly, the industrial PDA needs to be competent as a product by having anti-shock, waterproof, or heat resistance/cold resistance characteristics of over a certain level.

As such, it is necessary to manufacture the industrial PDA to be more firm or rigid than the general PDA, and particularly, to have a waterproof function to endure snow or rain. Since the industrial PDA is designed to have a structure to meet the requirements of the anti-shock, waterproof, or heat resistance/cold resistance characteristics of over a certain level and also to include a barcode scanner as described above, it is often that the external size of an industrial PDA is much greater than that of a general PDA. The size of an industrial PDA needs to be deceased for easy use by Asians having smaller hands than Westerners.

A side key is provided on a mobile terminal according to the related art. The side key is a button provided on a side surface, that is, a side, of a terminal main body. One or two or more side keys may be provided according to mobile terminals.

The side key may perform various functions such as a volume control function or a menu selection function in addition to a power on/off function.

As described above, mobile terminals that may be used for the industrial PDAs need to have a strong waterproof function.

In particular, like the side key, parts coupled to the terminal main body need to have a strong waterproof function and a separation prevention structure, and thus a mobile terminal may be used without problem. The side key is assembled in the following method.

To prevent escape of a side key, the side key is manufactured to be a silicon side key of a flange type and a bonding assembly structure corresponding to the side key is injected and assembled with the side key. Then, the side key is assembled with a terminal main body from the inside to the outside. A waterproof tape is attached on a portion where the side key contacts in the terminal main body. A reinforcement plate is added for reinforcement, and thus the side key is assembled with the terminal main body.

However, when the side key is assembled with the terminal main body by using parts such as the bonding assembly structure, the waterproof tape, and the reinforcement plate, as in the related art, the miniaturization of a product may be difficult due to a structural limitation. Furthermore, as the number of parts increase, man-hour increases and thus much loss is generated during manufacturing.

In particular, in the related art, since the waterproof tape used for reinforcement is attached to a portion where the side key contacts in the terminal main body, as an external motion that presses the side key continues, the waterproof tape or the reinforcement plate is highly likely to escape or to be deformed, and thus waterproof may not be performed.

### DETAILED DESCRIPTION OF THE INVENTIVE CONCEPT

### Technical Problem

The present inventive concept provides an externally-assembled waterproof side key assembly and a mobile terminal including the same, in which assembly may be possible with a minimum number of parts, thereby enabling miniaturization of a product, assemblability may be improved due to an external assembly method, thereby reducing generation of loss during manufacturing, and a waterproof function may be remarkably improved compared to the related art, thereby improving durability of a product.

### Advantageous Effects

According to the present inventive concept, since assembly may be possible with a minimum number of parts, miniaturization of a product may be implemented. Since assemblability may be improved due to an external assembly method, the generation of loss may be reduced during manufacturing. Since a waterproof function may be remarkably improved compared to the related art, durability of a product may be improved.

### DESCRIPTION OF THE DRAWINGS

FIG. 1 is a perspective view of a terminal main body of a mobile terminal according to an embodiment.

FIG. 2 is an enlarged view of an area A of FIG. 1.

FIG. 3 illustrates a state in which an externally-assembled waterproof side key assembly according to an embodiment is separated from the terminal main body in FIG. 2.

FIG. 4 is a perspective view of FIG. 3 illustrated at an angle.

FIG. 5 illustrates FIG. 2 from the rear side thereof.

FIG. 6 illustrates a state in which a shield portion is separated in FIG. 5.

FIG. 7 illustrates a state in which the externally-assembled waterproof side key assembly is separated in FIG. 6.

FIG. 8 is a schematic cross-sectional view of FIG. 2.

FIG. 9 is an exploded view of FIG. 8.

FIG. 10 is an enlarged view of a waterproof ring.

FIG. 11 is a horizontal cross-sectional view of a terminal main body of a mobile terminal according to another embodiment.

FIG. 12 is an enlarged exploded view of a major part of FIG. 11.

### BEST MODE

According to an aspect of the present inventive concept, a mobile terminal includes a terminal main body having a key assembly hole formed at at least a side thereof, and an externally-assembled waterproof side key assembly assembled from an outside of the terminal main body toward an area of the key assembly hole of the terminal main body, in which the externally-assembled waterproof side key assembly includes a side key having a protruding assembly terminal that is assembled by being inserted into the key assembly hole from the outside of the terminal main body, and a waterproof ring into which the protruding assembly terminal of the side key is inserted, the waterproof ring being disposed in the key assembly hole by being inserted into the key assembly hole from the outside of the terminal main body, and shielding a gap between the protruding assembly terminal and the key assembly hole for waterproof.

The side key may further include a key body in which the protruding assembly terminal is provided at a center are thereof, and an escape prevention hook protruding from one side of the key body in a same direction as the protruding assembly terminal, and preventing escape of the key body by being caught by the terminal main body.

The escape prevention hook may be symmetrically arranged at both sides of the key body with the protruding assembly terminal provided therebetween.

A hook catching boss having a catch step may be further formed on the terminal main body corresponding to the escape prevention hook, a hook head of the escape prevention hook being caught by the catch step.

The mobile terminal may further include a shield portion that shields an opening of the hook catching boss.

The shield portion may be a waterproof tape or waterproof silicon, and the waterproof ring may be an elastic waterproof ring formed of an elastic material.

A pressing pattern portion for improving a sense of touch may be formed on an outer surface of the key body, and a reinforcement portion for protecting the escape prevention hook may be formed on an inner surface of the key body.

The waterproof ring may include a ring body inserted into the key assembly hole, and a corrugated portion formed on an outer surface of the ring body, adhering to an inner wall of the key assembly hole, and preventing generation of a gap.

The waterproof ring may further include a catch flange formed at an end portion of the ring body and caught and supported by a step portion of the key assembly hole, and an elasticity providing dome portion protruding from an inner bottom surface of the ring body, at which an end portion of the protruding assembly terminal is located, and providing elasticity to allow the protruding assembly terminal to return to an original position.

The waterproof ring may further include an insert reinforcement portion that is inserted into the ring body and reinforcing the ring body.

A hook assembly hole having a catch step may be formed at one side of the terminal body corresponding to the escape prevention hook, a hook head of the escape prevention hook being caught by the catch step. The hook assembly hole may include a hook insertion section formed in a direction in which the escape prevention hook is inserted, and a bent section communicated with the hook insertion section, arranged across the hook insertion section, and having an end portion exit disposed at the outside of the terminal main body. The catch step may be formed at an intersection between the hook insertion section and the bent section.

According to another aspect of the present inventive concept, an externally-assembled waterproof side key assembly includes a side key having a protruding assembly terminal that is assembled by being inserted into a key assembly hole from an outside of the terminal main body, the key assembly hole being formed at at least one side of the terminal main body, and a waterproof ring into which the protruding assembly terminal of the side key is inserted, the waterproof ring being disposed in the key assembly hole by being inserted into the key assembly hole from the outside of the terminal main body, and shielding a gap between the protruding assembly terminal and the key assembly hole for waterproof.

The side key may include a key body in which the protruding assembly terminal is provided at a center are thereof, and an escape prevention hook protruding from one side of the key body in a same direction as the protruding assembly terminal, and preventing escape of the key body by being caught by the terminal main body.

The waterproof ring may include a ring body inserted into the key assembly hole, and a corrugated portion formed on an outer surface of the ring body, adhering to an inner wall of the key assembly hole, and preventing generation of a gap.

The waterproof ring may include a catch flange formed at an end portion of the ring body and caught and supported by a step portion of the key assembly hole, and an elasticity providing dome portion protruding from an inner bottom surface of the ring body, at which an end portion of the protruding assembly terminal is located, and providing elasticity to allow the protruding assembly terminal to return to an original position.

The waterproof ring may include an insert reinforcement portion that is inserted into the ring body and reinforcing the ring body.

A hook assembly hole having a catch step may be formed at one side of the terminal body corresponding to the escape prevention hook, a hook head of the escape prevention hook being caught by the catch step. The hook assembly hole may include a hook insertion section formed in a direction in which the escape prevention hook is inserted, and a bent section communicated with the hook insertion section, arranged across the hook insertion section, and having an end portion exit disposed at the outside of the terminal main body. The catch step may be formed at an intersection between the hook insertion section and the bent section.

### Mode of the Inventive Concept

The attached drawings for illustrating preferred embodiments of the present inventive concept are referred to in order to gain a sufficient understanding of the present inventive concept, the merits thereof, and the objectives accomplished by the implementation of the present inventive concept.

Hereinafter, the present inventive concept will be described in detail by explaining preferred embodiments of the inventive concept with reference to the attached drawings. Like reference numerals in the drawings denote like elements.

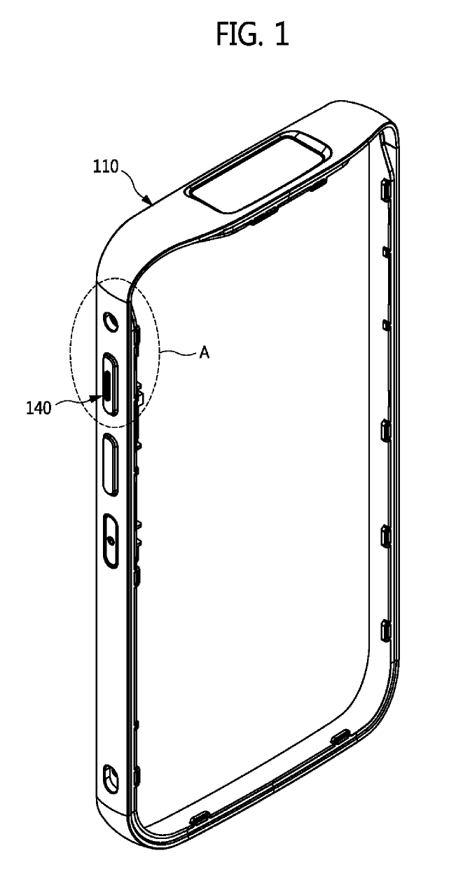

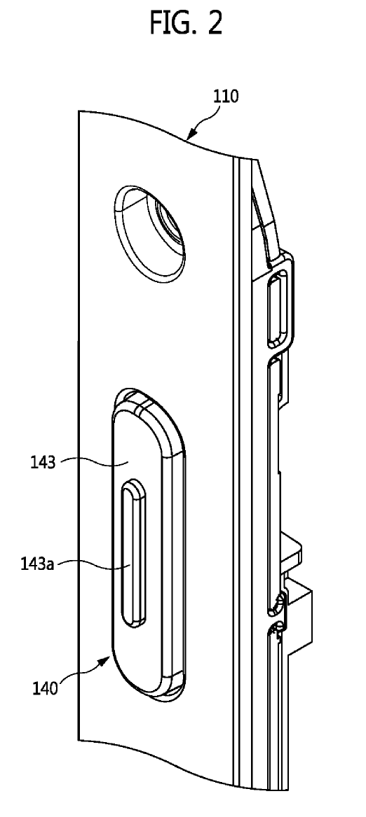

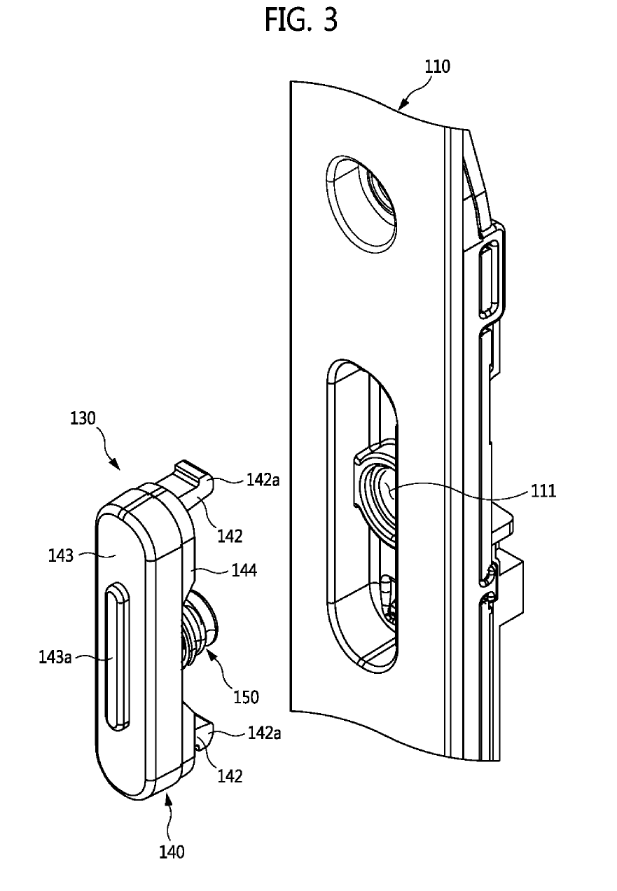

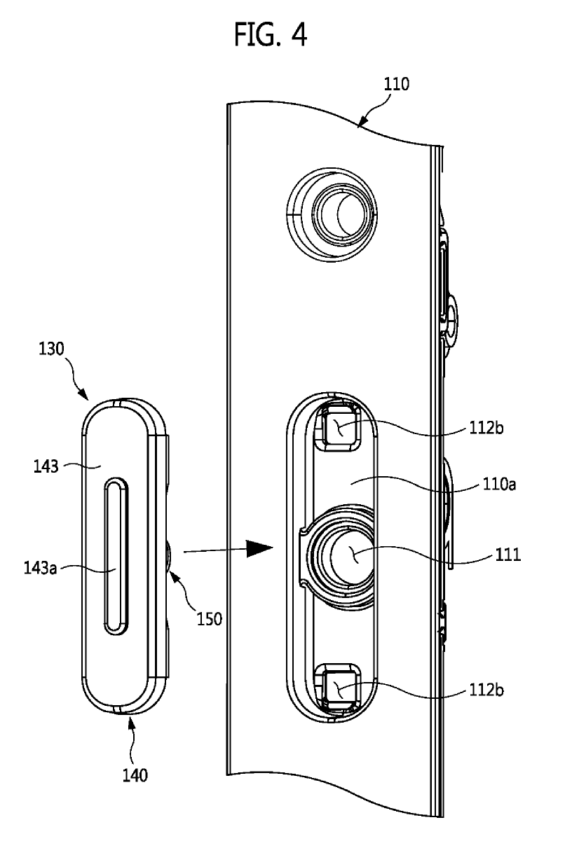

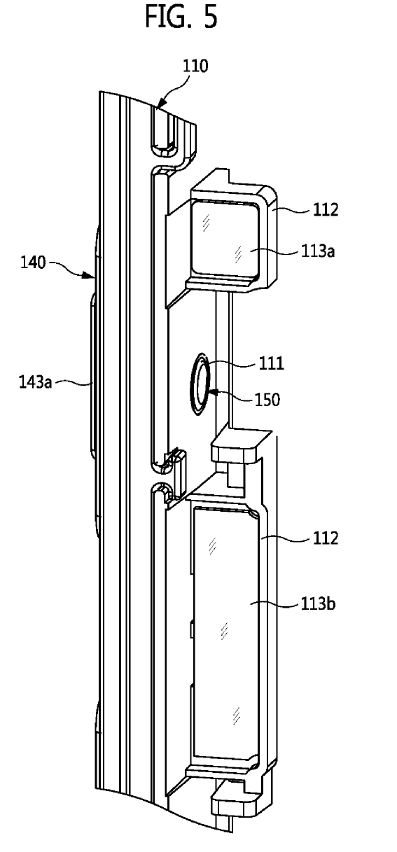

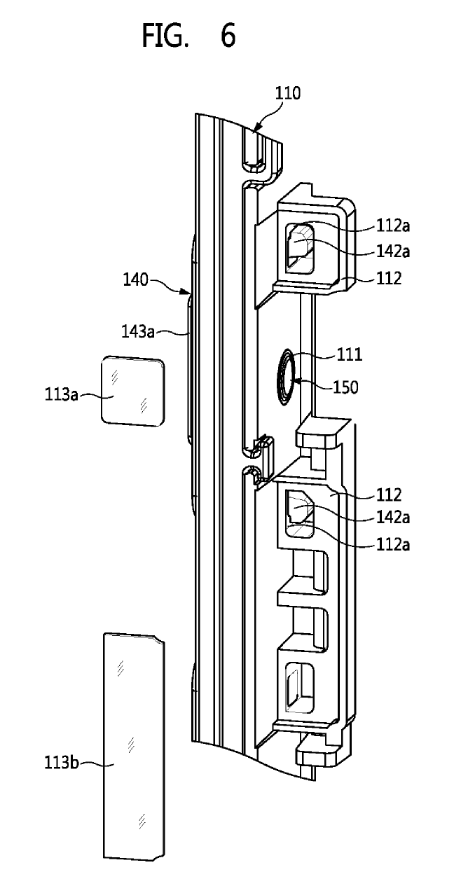

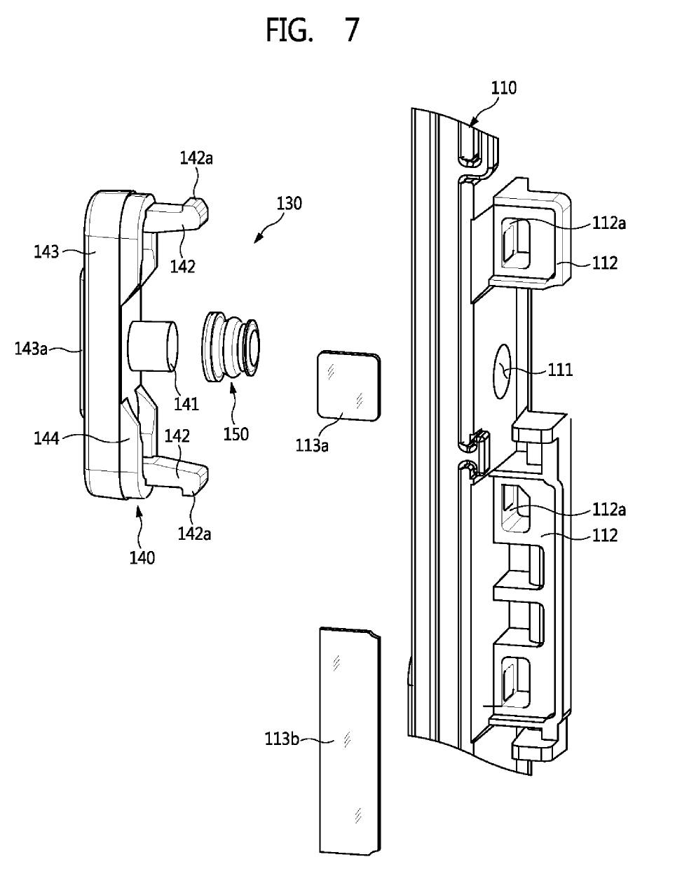

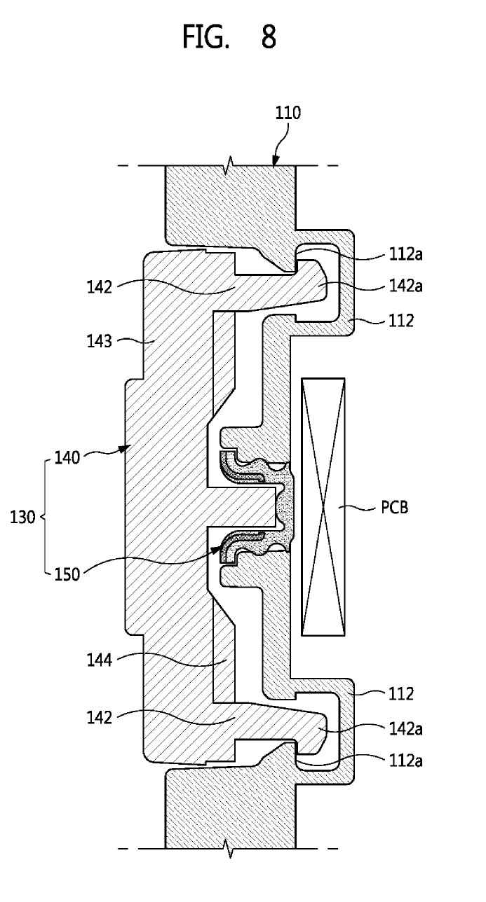

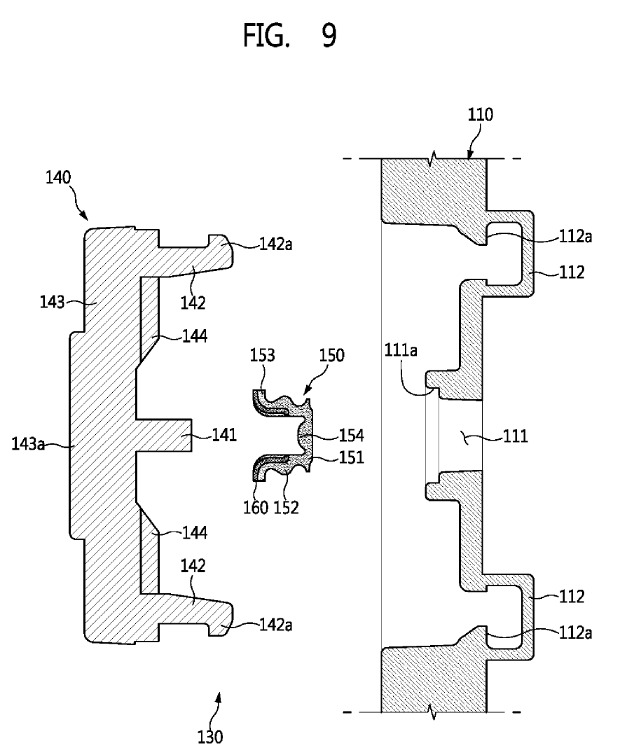

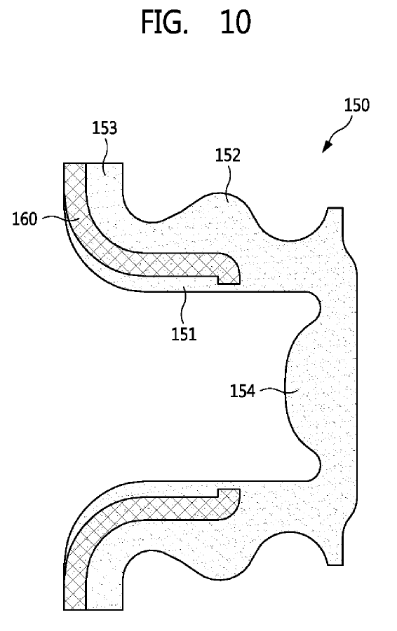

FIG. 1 is a perspective view of a terminal main body of a mobile terminal according to an embodiment. FIG. 2 is an enlarged view of an area A of FIG. 1. FIG. 3 illustrates a state in which an externally-assembled waterproof side key assembly according to an embodiment is separated from the terminal main body in FIG. 2. FIG. 4 is a perspective view of FIG. 3 illustrated at an angle. FIG. 5 illustrates FIG. 2 from the rear side thereof. FIG. 6 illustrates a state in which a shield portion is separated in FIG. 5. FIG. 7 illustrates a state in which the externally-assembled waterproof side key assembly is separated in FIG. 6. FIG. 8 is a schematic cross-sectional view of FIG. 2. FIG. 9 is an exploded view of FIG. 8. FIG. 10 is an enlarged view of a waterproof ring.

Referring to these drawings, according to a mobile terminal according to the present embodiment, contrary to the related art, assembly may be possible with a minimum number of parts, thereby enabling miniaturization of a product, assemblability may be improved due to an external assembly method, thereby reducing generation of loss during manufacturing, and a waterproof function may be remarkably improved compared to the related art, thereby improving durability of a product. The mobile terminal according to the present embodiment may include a terminal main body 110 and an externally-assembled waterproof side key assembly 130 that is assembled from the outside of the terminal main body 110 toward the inside thereof. The terminal main body 110 indicates all parts other than the externally-assembled waterproof side key assembly 130. In other words, various types of internal parts and an outer case are collectively referred to as the terminal main body 110.

The terminal main body 110 according to the present embodiment may be a terminal main body of an industrial personal digital assistant (PDA).

This is a mere example, and the terminal main body 110 is not limited to an industrial PDA. The terminal main body 110 may be, for example, a main body of smartphones that are widely distributed, or a main body of existing 2G phones, for example folder phones or slide phones.

As illustrated in FIG. 4, a side key assembly groove portion 110a is formed in a side wall of the terminal main body 110. A key assembly hole 111 and a plurality of hook assembly holes 112b are formed in the side key assembly groove portion 110a. The externally-assembled waterproof side key assembly 130 according to an embodiment may be assembled in the side key assembly groove portion 110a.

The externally-assembled waterproof side key assembly 130 is a part that is assembled from the outside of the terminal main body 110 toward the side key assembly groove portion 110a, and may include a side key 140 and a waterproof ring 150.

In the present embodiment, since the externally-assembled waterproof side key assembly 130 includes parts such as the side key 140 and the waterproof ring 150, assembly is possible with the minimum number of parts unlike the related art, and thus miniaturization of a product may be implemented.

In the present embodiment, since the externally-assembled waterproof side key assembly 130 is assembled from the outside of the terminal main body 110 toward the side key assembly groove portion 110a as indicated by an arrow in FIG. 4, assemblability thereof may be improved compared to an internal assembly method of the related art, and thus generation of loss during manufacturing may be reduced.

In addition, in the present embodiment, due to the side key 140 and the waterproof ring 150, and an efficient structure of the terminal main body 110, the externally-assembled waterproof side key assembly 130 is not freely detached and a waterproof function is quite improved compared to the related art, and thus durability of a product may be enhanced.

The structure of the externally-assembled waterproof side key assembly 130 is described in detail below. First, the side key 140 is a part that is assembled by being inserted from the outside of the terminal main body 110 into the key assembly hole 111.

The side key 140 may perform various functions such as a power on/off function, a volume control function, or a menu selection function, as described above. In other words, when the side key 140 is pressed, a signal is transmitted to a PCB (see FIG. 8) in the terminal main body 110, and thus various function such as a power on/off function, a volume control function, or a menu selection function may be performed. As illustrated in FIGS. 2 to 4, the side key 140 may be coupled to the terminal main body 110 by being inserted into the side key assembly groove portion 110a.

For reference, in FIG. 1, a plurality of side keys 140 are provided to the terminal main body 110. These side keys 140 are all regarded to have the same structure and function as those described below.

The side key 140 may include a key body 143, a protruding assembly terminal 141 (see FIG. 7) provided at a center area of the key body 143, and an escape prevention hook 142 provided on the key body 143 next to the protruding assembly terminal 141.

The key body 143 forms a frame of the side key 140. Although in the present embodiment the key body 143 has a long oval shape, the right scope of the present invention is not limited to the shape illustrated in the drawings.

A pressing pattern portion 143a for improving a sense of touch is formed on an outer surface of the key body 143. A pair of reinforcement portions 144 are formed on an inner surface of the key body 143. The reinforcement portions 144 protect the escape prevention hook 142 from being easily broken.

The protruding assembly terminal 141 is a part protruding from a central area of the key body 143. During assembly, the waterproof ring 150 is inserted around the protruding assembly terminal 141, and the protruding assembly terminal 141 is inserted with the waterproof ring 150 into the key assembly hole 111 from the outside of the terminal main body 110. When the side key 140 is pressed, an end portion of the protruding assembly terminal 141 presses a terminal of the PCB to transmit a signal to the PCB, and thus various functions such as a power on/off function, a volume control function, or a menu selection function may be performed.

The escape prevention hook 142 prevents the side key 140 from being freely detached from the side key assembly groove portion 110a after being assembled from the outside of the terminal main body 110 toward the side key assembly groove portion 110a.

In other words, the escape prevention hook 142 protrudes from one side of the key body 143 in the same direction as the protruding assembly terminal 141, and is caught by a catch step 112a of a hook catching boss 112 of the terminal main body 110, thereby preventing escape of the key body 143.

In the present embodiment, the escape prevention hook 142 may be symmetrically arranged at both sides of the key body 143 with the protruding assembly terminal 141 provided therebetween. Accordingly, the side key 140 may be stably assembled.

The hook catching boss 112 having the catch step 112a by which a hook head 142a of the escape prevention hook 142 is caught is formed on the terminal main body 110, corresponding to the escape prevention hook 142. Since the hook head 142a of the escape prevention hook 142 inserted into the hook catching boss 112 via the hook assembly holes 112b is caught by the catch step 112a of the hook catching boss 112, the side key 140 may be prevented from being freely detached from the side key assembly groove portion 110a.

The hook catching boss 112 may be provided on the terminal main body 110 as many as the number of the escape prevention hooks 142. Since two escape prevention hooks are provided for one side key, two hook catching bosses may be provided for one side key. In the present embodiment, although the sizes of the hook catching bosses 112 are different from each other, all sizes and shapes thereof may be the same.

As illustrated in FIGS. 5 to 7, the hook catching boss 112 has a shape having one open side. Shield portions 113a and 113b are provided in the open side of the hook catching boss 112 to shield an opening of the hook catching boss 112. Accordingly, a waterproof function may be provided.

As described above, since the sizes of the hook catching bosses 112 are different from each other, the sizes of the shield portions 113a and 113b are illustrated to be different from each other. When the sizes of the hook catching bosses 112 are the same, the sizes of the shield portions 113a and 113b may be identical to each other. In the present embodiment, a waterproof tape or waterproof silicon may be used as the shield portions 113a and 113b.

Next, the waterproof ring 150 is inserted around the protruding assembly terminal 141 of the side key 140 in a direction from the outside of the terminal main body 110 toward the key assembly hole 111, and arranged in the key assembly hole 111. The waterproof ring 150 shields a gap between the protruding assembly terminal 141 and the key assembly hole 111.

In other words, in the present embodiment, the waterproof ring 150 is also assembly externally. The waterproof ring 150 shields a gap that may be generated in an area of the key assembly hole 111, and thus leakage may not be generated.

Since the opening of the hook catching boss 112 is shielded by the shield portions 113a and 113b and the gap of the key assembly hole 111 is sealed by the waterproof ring 150, even when the externally-assembled waterproof side key assembly 130 according to the present embodiment is assembled externally, there may be no problem in the waterproof function. Rather, the present disclose may provide superior assemblability and excellent waterproof effect compared to the related art.

In the present embodiment, the waterproof ring 150 may be an elastic waterproof ring 150 formed of an elastic material. The waterproof ring 150 may include a ring body 151, a corrugated portion 152, a catch flange 153, and an elasticity providing dome portion 154. Although for convenience of explanation the waterproof ring 150 is described as having the ring body 151, the corrugated portion 152, the catch flange 153, and the elasticity providing dome portion 154, these components may be provided as one body.

The ring body 151 is a part that forms a frame of the waterproof ring 150, into which the protruding assembly terminal 141 of the side key 140 is inserted, and is inserted into the key assembly hole 111. The ring body 151 may have a pocket shape.

The corrugated portion 152 is formed on an outer surface of the ring body 151, and adhering to an inner wall of the key assembly hole 111, thereby preventing generation of a gap. In other words, when the waterproof ring 150 is inserted into the key assembly hole 111, the corrugated portion 152 is pressed to closely contact the inner wall of the key assembly hole 111, overlapping, thereby forming a complete seal.

The catch flange 153 is a part formed on an end portion of the ring body 151 and caught and supported by a step portion 111a of the key assembly hole 111. The catch flange 153 prevents the waterproof ring 150 from being completely inserted into the terminal main body 110 and escaping therefrom.

The elasticity providing dome portion 154 is a part protruding from an inner bottom surface of the ring body 151. The elasticity providing dome portion 154 is a part where the end portion of the protruding assembly terminal 141 of the side key 140 is located, and provides elasticity to return the protruding assembly terminal 141 to the original position. In other words, when the side key 140 is pressed from the outside, the protruding assembly terminal 141 presses the elasticity providing dome portion 154, and thus a signal is transmitted to the PCB in the terminal main body 110 (see FIG. 8). When the force pressing the side key 140 is removed, the elasticity providing dome portion 154 is elastically returned to the original state, and pushes the protruding assembly terminal 141 such that the side key 140 may be returned to the original position.

An insert reinforcement portion 160 is provided inside the ring body 151 of the waterproof ring 150. Unlike the waterproof ring 150 formed of an elastic material, the insert reinforcement portion 160 is formed of a material having rigidity, for example, hard synthetic resin or metal, and is inserted into the ring body 151 of the waterproof ring 150, thereby reinforcing the ring body 151. In particular, the insert reinforcement portion 160 is placed biased to the side of the catch flange 153 of the waterproof ring 150, the catch flange 153 may not be deformed and may be appropriately caught by and supported on the step portion 111a of the key assembly hole 111.

As described above, as the waterproof ring 150 is inserted around the protruding assembly terminal 141 of the side key 140 and then the waterproof ring 150 is inserted into the key assembly hole 111 of the terminal main body 110, as illustrated in FIG. 3, the externally-assembled waterproof side key assembly 130 may be easily assembled from the outside of the terminal main body 110.

In particular, although the externally-assembled waterproof side key assembly 130 is not assembled inside the terminal main body 110 contrary to the related art, the escape of the externally-assembled waterproof side key assembly 130 may be effectively prevented, the opening of the hook catching boss 112 may be shielded by the shield portions 113a and 113b, and the gap of the key assembly hole 111 may be sealed by the waterproof ring 150. Accordingly, even when the externally-assembled waterproof side key assembly 130 according to the present embodiment is externally assembly, there may be no problem in the waterproof function. Rather, the present disclose may provide superior assemblability and excellent waterproof effect compared to the related art.

According to the present embodiment having the above structure and operation, assembly with a minimum number of parts may be possible so that miniaturization of a product is available. Also, since assemblability may be improved due to the external assembly method, generation of loss during manufacturing may be reduced. Furthermore, since the waterproof function may be greatly improved compared to the related art, durability of a product may be improved.

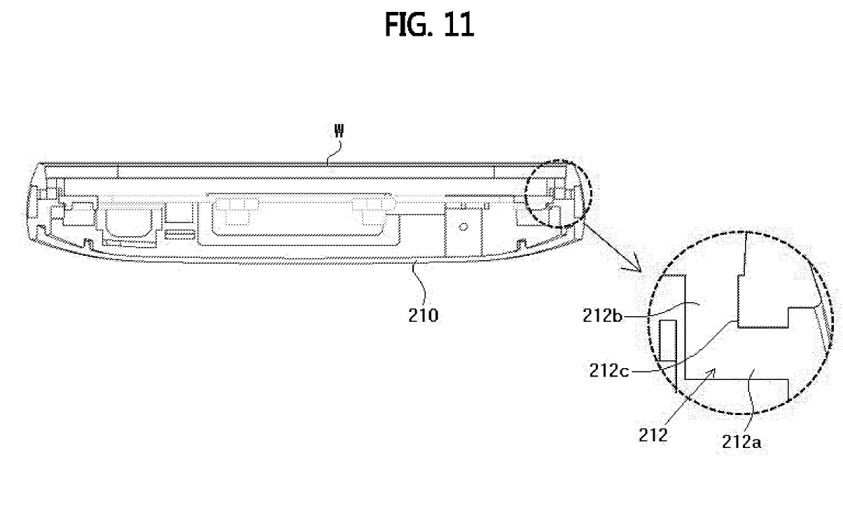

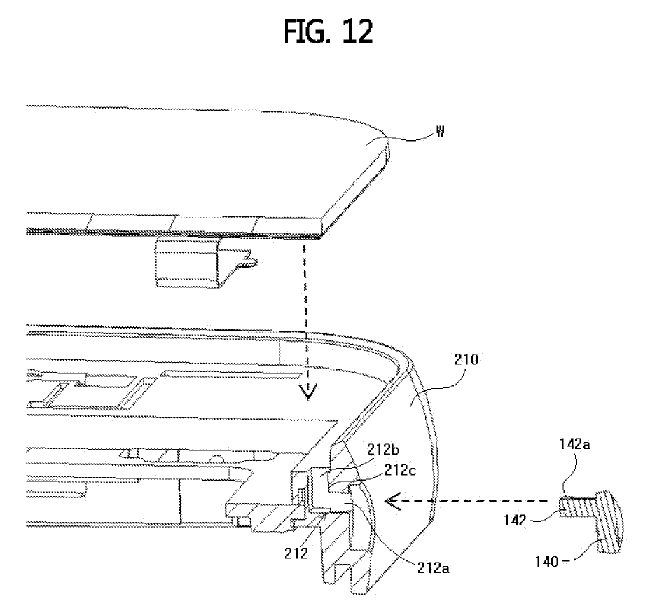

FIG. 11 is a horizontal cross-sectional view of a terminal main body of a mobile terminal according to another embodiment. FIG. 12 is an enlarged exploded view of a major part of FIG. 11.

To assemble the side key 140 from the outside of a terminal main body 210, a hook assembly hole 212, into which the escape prevention hook 142 of the side key 140 is inserted for assembly, is formed in a side wall of the terminal main body 210.

In this state, the hook assembly hole 212 has a structure that does not penetrate through the inside of the terminal main body 210, and penetrates through the inside of the terminal main body 210 by being bent outwardly toward a portion where liquid crystal W is located.

In other words, in the present embodiment, the hook assembly hole 212 may include a hook insertion section 212a formed in a direction in which the escape prevention hook 142 is inserted, a bent section 212b communicating with the hook insertion section 212a across the hook insertion section 212a and having an end portion exit that is disposed at the outside of the terminal main body 210 where the liquid crystal W is located, and a catch step 212c formed at an intersection between the hook insertion section 212a and the bent section 212b and where the hook head 142a of the escape prevention hook 142 is caught.

For reference, in the present embodiment, although the end portion exit of the bent section 212b is disposed at the outside of the terminal main body 210 where the liquid crystal W is located, the end portion exit may be arranged at the opposite side of the liquid crystal W, that is, at a battery side of the terminal main body 210. In other words, it is enough that the end portion exit of the bent section 212b does not penetrate through the inside of the terminal main body 210.

When the hook assembly hole 212 includes the hook insertion section 212a and the bent section 212b and the catch step 212c is formed between the hook insertion section 212a and the bent section 212b, as in the present embodiment, the above-described shield portions 113a and 113b (see FIG. 7) are not needed. In other words, when the hook assembly hole 212 is formed in a bent shape, not in a linear shape, and the end portion exit is formed at the outside of the terminal main body 210, not at the inside of the terminal main body 210, the catch step 212c is naturally formed, and thus the escape prevention hook 142 may be caught well and further the outside of the terminal main body 210 may be shielded by the liquid crystal W. Accordingly, the shield portions 113a and 113b (see FIG. 7) used in the above-described embodiment may not be used.

Consequently, in the present embodiment, since the external assembly of the side key 140 is implemented by a simple method of forming the hook assembly hole 212 at the outside of the terminal main body 210, not at the inside thereof, a waterproof function may be obtained. Accordingly, a separate processing process of internal parts may be omitted, and thus costs may be reduced and a defect rate may be reduced, thereby contributing to enhancement of productivity.

While this inventive concept has been particularly shown and described with reference to preferred embodiments thereof, it will be understood by those of ordinary skill in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

### INDUSTRIAL APPLICABILITY

The present inventive concept may be used for an industrial or personal mobile terminal.

1. A mobile terminal comprising:
a terminal main body having a key assembly hole formed at at least a side thereof; and
an externally-assembled waterproof side key assembly assembled from an outside of the terminal main body toward an area of the key assembly hole of the terminal main body, wherein the externally-assembled waterproof side key assembly comprises:
a side key having a protruding assembly terminal that is assembled by being inserted into the key assembly hole from the outside of the terminal main body; and
a waterproof ring into which the protruding assembly terminal of the side key is inserted, the waterproof ring being disposed in the key assembly hole by being inserted into the key assembly hole from the outside of the terminal main body, and shielding a gap between the protruding assembly terminal and the key assembly hole for waterproof.

2. The mobile terminal of claim 1, wherein the side key further comprises:
a key body in which the protruding assembly terminal is provided at a center are thereof; and
an escape prevention hook protruding from one side of the key body in a same direction as the protruding assembly terminal, and preventing escape of the key body by being caught by the terminal main body.

3. The mobile terminal of claim 2, wherein the escape prevention hook is symmetrically arranged at both sides of the key body with the protruding assembly terminal provided therebetween.

4. The mobile terminal of claim 2, wherein a hook catching boss having a catch step is further formed on the terminal main body corresponding to the escape prevention hook, a hook head of the escape prevention hook being caught by the catch step.

5. The mobile terminal of claim 4, further comprising a shield portion that shields an opening of the hook catching boss.

6. The mobile terminal of claim 5, wherein the shield portion is a waterproof tape or waterproof silicon, and the waterproof ring is an elastic waterproof ring formed of an elastic material.

7. The mobile terminal of claim 2, wherein a pressing pattern portion for improving a sense of touch is formed on an outer surface of the key body, and a reinforcement portion for protecting the escape prevention hook is formed on an inner surface of the key body.

8. The mobile terminal of claim 1, wherein the waterproof ring comprises:
a ring body inserted into the key assembly hole; and
a corrugated portion formed on an outer surface of the ring body, adhering to an inner wall of the key assembly hole, and preventing generation of a gap.

9. The mobile terminal of claim 8, wherein the waterproof ring further comprises:
a catch flange formed at an end portion of the ring body and caught and supported by a step portion of the key assembly hole; and
an elasticity providing dome portion protruding from an inner bottom surface of the ring body, at which an end portion of the protruding assembly terminal is located, and providing elasticity to allow the protruding assembly terminal to return to an original position.

10. The mobile terminal of claim 8, wherein the waterproof ring further comprises an insert reinforcement portion that is inserted into the ring body and reinforcing the ring body.

11. The mobile terminal of claim 2, wherein a hook assembly hole having a catch step is formed at one side of the terminal body corresponding to the escape prevention hook, a hook head of the escape prevention hook being caught by the catch step, the hook assembly hole comprises:
a hook insertion section formed in a direction in which the escape prevention hook is inserted; and
a bent section communicated with the hook insertion section, arranged across the hook insertion section, and having an end portion exit disposed at the outside of the terminal main body, and the catch step is formed at an intersection between the hook insertion section and the bent section.

12. An externally-assembled waterproof side key assembly comprising:
a side key having a protruding assembly terminal that is assembled by being inserted into a key assembly hole from an outside of the terminal main body, the key assembly hole being formed at at least one side of the terminal main body; and
a waterproof ring into which the protruding assembly terminal of the side key is inserted, the waterproof ring being disposed in the key assembly hole by being inserted into the key assembly hole from the outside of the terminal main body, and shielding a gap between the protruding assembly terminal and the key assembly hole for waterproof.

13. The externally-assembled waterproof side key assembly of claim 12, wherein the side key comprises:
a key body in which the protruding assembly terminal is provided at a center are thereof; and
an escape prevention hook protruding from one side of the key body in a same direction as the protruding assembly terminal, and preventing escape of the key body by being caught by the terminal main body.

14. The externally-assembled waterproof side key assembly of claim 12, wherein the waterproof ring comprises:
a ring body inserted into the key assembly hole; and
a corrugated portion formed on an outer surface of the ring body, adhering to an inner wall of the key assembly hole, and preventing generation of a gap.

15. The externally-assembled waterproof side key assembly of claim 14, wherein the waterproof ring comprises:
a catch flange formed at an end portion of the ring body and caught and supported by a step portion of the key assembly hole; and
an elasticity providing dome portion protruding from an inner bottom surface of the ring body, at which an end portion of the protruding assembly terminal is located, and providing elasticity to allow the protruding assembly terminal to return to an original position.

16. The externally-assembled waterproof side key assembly of claim 14, wherein the waterproof ring comprises an insert reinforcement portion that is inserted into the ring body and reinforcing the ring body.

17. The externally-assembled waterproof side key assembly of claim 13, wherein a hook assembly hole having a catch step is formed at one side of the terminal body corresponding to the escape prevention hook, a hook head of the escape prevention hook being caught by the catch step, the hook assembly hole comprises:
a hook insertion section formed in a direction in which the escape prevention hook is inserted; and
a bent section communicated with the hook insertion section, arranged across the hook insertion section, and having an end portion exit disposed at the outside of the terminal main body, and the catch step is formed at an intersection between the hook insertion section and the bent section.
